(19) United States
(12) Patent Application Publication
(10) Pub. No.: US 2017/0334335 A1
(43) Pub. Date: Nov. 23, 2017

(54) POWER SUPPLY DEVICE USED FOR WHEEL RIM

(71) Applicant: HUNG-CHUAN WU, Taoyuan (TW)

(72) Inventor: HUNG-CHUAN WU, Taoyuan (TW)

(21) Appl. No.: 15/157,596

(22) Filed: May 18, 2016

(51) Int. Cl. B60Q 1/00; B60Q 1/34; B60B 7/04; B60Q 1/26; B60B 7/00; B60L 1/14; B60Q 1/44; B60Q 1/32

(52) U.S. Cl. CPC B60Q 1/0017; B60Q 1/44; B60Q 1/34; B60Q 1/326; B60Q 1/2696; B60B 7/0013; B60Q 1/0011; B60L 1/14; B60B 7/04; B60Q 1/2661

(57) ABSTRACT

A power supply device used for a wheel rim is mounted on a wheel rim of a vehicle. The power supply device includes a magnetism assembly, an axle member, a magnet, a weight block, a seat, a coil module, and a control module. The seat is disposed on the wheel rim. One side of the seat is provided with an axle seat for connection of the axle member. The seat is driven by the wheel rim to turn relative to the magnetism assembly. When the seat is turned to generate power through the magnet and the coil module, the control module selectively transmits the power to a light-emitting device provided on the wheel rim.

### BACKGROUND OF THE INVENTION

### 1. Field of the Invention

The present invention relates to a power supply device used for a wheel rim, and more particularly to a power supply device which is installed on a wheel rim and driven by the wheel rim to turn for generating power to a light-emitting device provided on the wheel rim.

### 2. Description of the Prior Art

With the rapid development of industrial technology to stimulate economic growth and social prosperity, the national income increases and the consumption level is also improved. In particular, the essential consumer spending for the basic necessities of life increases rapidly. With regard to transport, most families have a vehicle for use.

In these days, a vehicle has become an indispensable means of transport in our daily lives for work, travel, sightseeing, and the like.

In order to improve the warning effect for the coming of a vehicle, the vehicle may be provided with a light-emitting device. Some people install the light-emitting device on a wheel rim. However, the light-emitting device needs power to actuate the light-emitting device. A convention light-emitting device uses a vehicular battery or solar energy to generate power. This way has the following shortcomings.

1. It is not easy to arrange the wiring of the light-emitting device disposed on the shaped surface of the wheel rim.

2. The vehicular battery has to supply additional power to the light-emitting device, which increases electricity consumption and shortens the service life of the battery.

3. Most people park their cars on a basement or an indoor garage. The power ratio of electricity transformation is not good, and the power is not enough for driving the related light-emitting modules.

Accordingly, the inventor of the present invention has devoted himself based on his many years of practical experiences to solve these problems.

### SUMMARY OF THE INVENTION

In view of the problems of the prior art, the primary object of the present invention is to provide a power supply device mounted on a wheel rim and driven by the wheel rim to turn for generating power to a light-emitting device provided on the wheel rim.

In order to achieve the aforesaid object, the power supply device used for a wheel rim of the present invention is mounted on a wheel rim of a vehicle. The power supply device comprises a magnetism assembly, a seat, a coil module, and a control module.

The magnetism assembly comprises a base, an axle member, a magnet, and a weight block. The axle member is disposed at the center of a first side of the base. The magnet is disposed around the first side of the base. The weight block is disposed on a second side of the base opposite the axle member. The seat is disposed on the wheel rim. A first side of the seat is provided with an axle seat for connection of the axle member. The seat is driven by the wheel rim to turn relative to the magnetism assembly. The coil module is disposed on the first side of the seat. The coil module is disposed around the axle seat. The control module is disposed inside the seat. When the seat is turned to generate power through the magnet and the coil module, the control module selectively transmits the power to a light-emitting device provided on the wheel rim.

### BRIEF DESCRIPTION OF THE DRAWINGS

FIG. 1 is a first schematic view of the power supply device used for a wheel rim in accordance with a first embodiment of the present invention;

FIG. 2 is a second schematic of the power supply device used for a wheel rim in accordance with the first embodiment of the present invention;

FIG. 3 is a first schematic view of the power supply device used for a wheel rim in accordance with the first embodiment of the present invention mounted to a wheel rim;

FIG. 4 is a second schematic view of the power supply device used for a wheel rim in accordance with the first embodiment of the present invention mounted to a wheel rim;

FIG. 5 is a third schematic view of the power supply device used for a wheel rim in accordance with the first embodiment of the present invention mounted to a wheel rim;

FIG. 6 is a block diagram of the power supply device used for a wheel rim and the light-emitting device in accordance with the first embodiment of the present invention connected with the driving vehicle;

FIG. 7a is a schematic view of a first embodiment of the light-emitting device of the present invention;

FIG. 7b is a schematic view of a second embodiment of the light-emitting device of the present invention;

FIG. 7c is a schematic view of a third embodiment of the light-emitting device of the present invention;

FIG. 8a is a schematic view showing that the power supply device in accordance with the first embodiment of the present invention is mounted to a wheel rim and controlled by an electronic control unit to perform a right turning;

FIG. 8b is a schematic view showing that the power supply device in accordance with the first embodiment of the present invention is mounted to a wheel rim and controlled by an electronic control unit to perform a brake;

FIG. 9 is a first schematic view of the power supply device used for a wheel rim in accordance with a second embodiment of the present invention; and

FIG. 10 is a second schematic of the power supply device used for a wheel rim in accordance with the second embodiment of the present invention.

### DETAILED DESCRIPTION OF THE PREFERRED EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

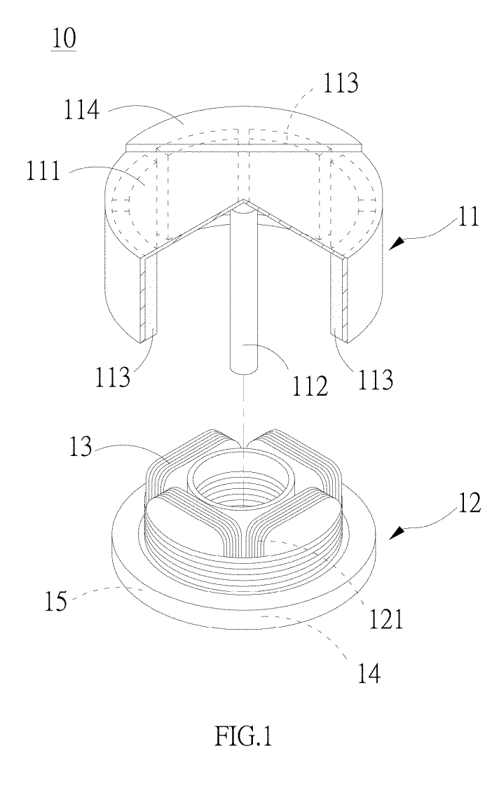

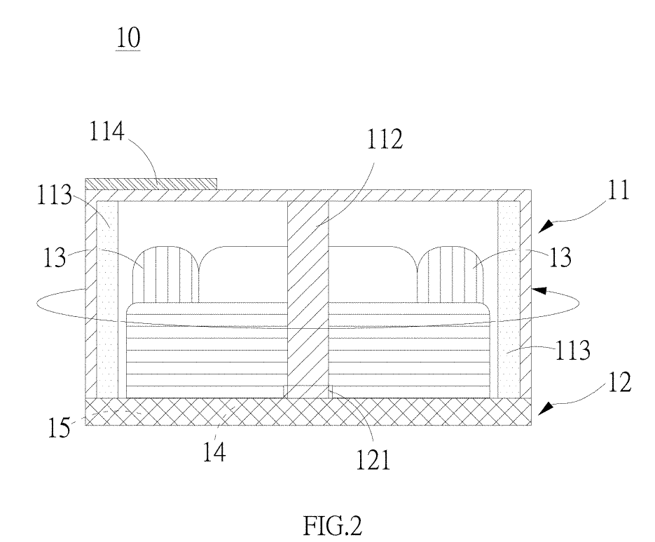

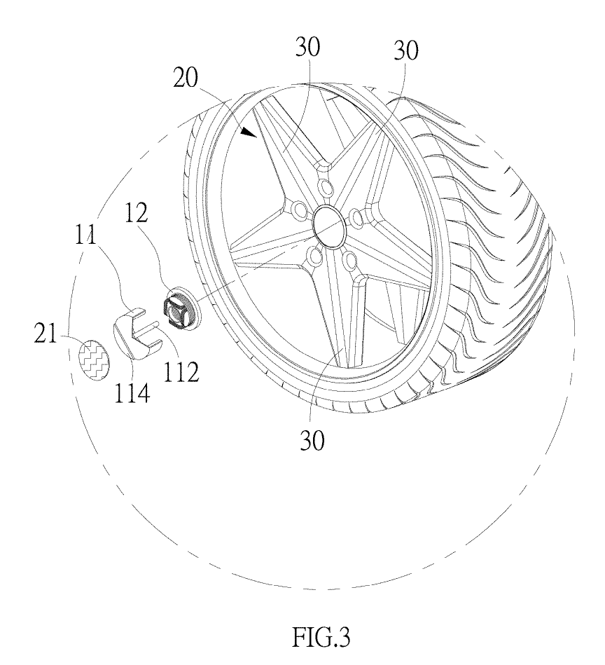

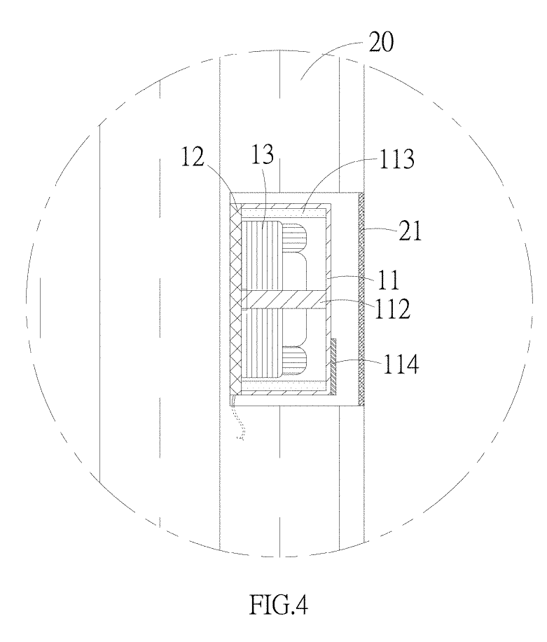

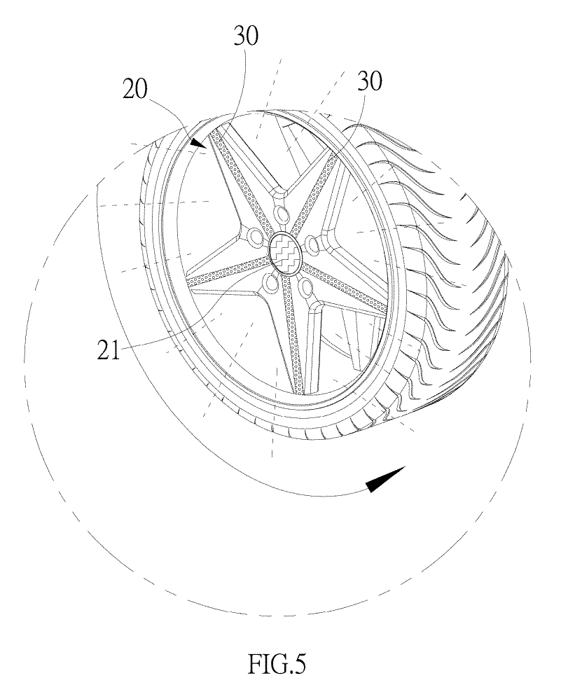

FIG. 1 and FIG. 2 are first and second schematic views of a power supply device used for a wheel rim in accordance with a first embodiment of the present invention. FIG. 3, FIG. 4 and FIG. 5 are first, second and third schematic views of the power supply device used for a wheel rim in accordance with the first embodiment of the present invention mounted to a wheel rim. A power supply device 10 used for a wheel rim of the present invention is mounted on a wheel rim 20. By means of turning of the wheel rim 20 of a driving vehicle, the power supply device 10 generates power to a light-emitting device 30 mounted on the wheel rim 20, so that the light-emitting device 30 emits light to provide a warning effect for the coming of a vehicle.

In a first embodiment, the power supply device 10 comprises a magnetism assembly 11, a seat 12, a coil module 13, a control module 14, and a power storage module 15. As shown in FIG. 1 and FIG. 2, the magnetism assembly 11 comprises a base 111, an axle member 112, a magnet 113, and a weight block 14. The axle member 112 is disposed at the center of a first side of the base 111. The magnet 113 is disposed around the first side of the base 111. The weight block 114 is disposed on a second side of the base 111 opposite the axle member 112. The seat 12 is disposed on the wheel rim 20. A first side of the seat 12 is provided with an axle seat 121 for connection of the axle member 112. The seat 12 is driven by the wheel rim 20 to turn relative to the magnetism assembly 11. It is noted that the magnetism assembly 11 is provided with the weight block 114. When the wheel rim 20 is turned, only the seat 12 is turned along with the wheel rim 20. The coil module 13 is disposed on the first side of the seat 12. The coil module 13 is disposed around the axle seat 121. When the seat 12 is coupled to the magnetism assembly 11, the coil module 13 is located close to the magnet 113. When the seat 12 is turned relative to the magnetism assembly 11, the coil module 13 and the magnet 113 bring an action to generate power. The control module 14 is disposed inside the seat 12. When the seat 12 is turned to generate power through the magnet 113 and the coil module 13, the power is transmitted to the light-emitting device 30 on the wheel rim 20 by the control module 14. When the vehicle is driving, the light-emitting device 30 emits light continuously or intermittently. As shown in FIG. 5, the power storage module 15 is disposed inside the seat 12 and connected with the control module 14 for storing the power generated by the magnet 113 and the coil module 13. Preferably, the power supply device 10 is embedded in a recess of the center of the wheel rim 20. For example, the seat 12 is disposed on the wheel rim 20 by binding. The wheel rim 20 is provided with a wheel rim cover 21 to cover the power supply device 10, as shown in FIG. 3 to FIG. 5.

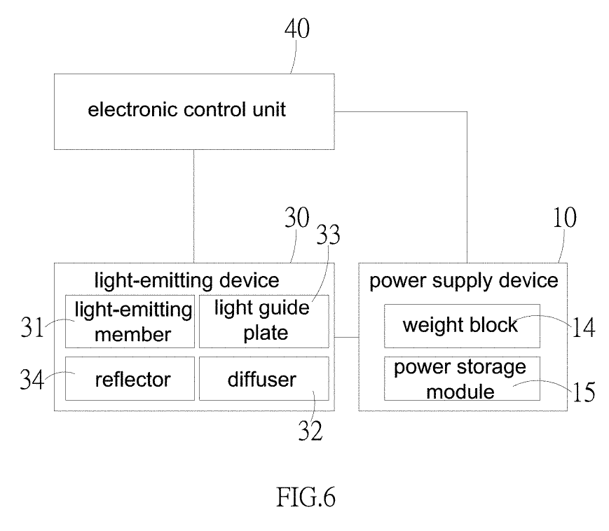

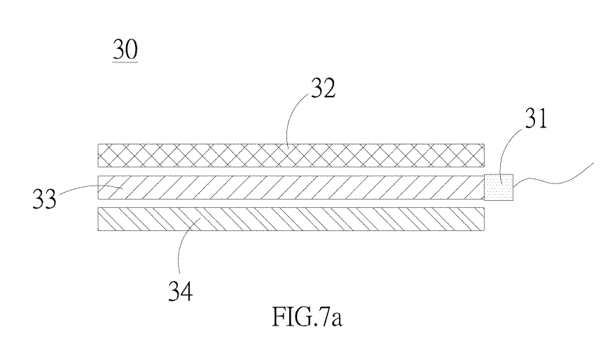

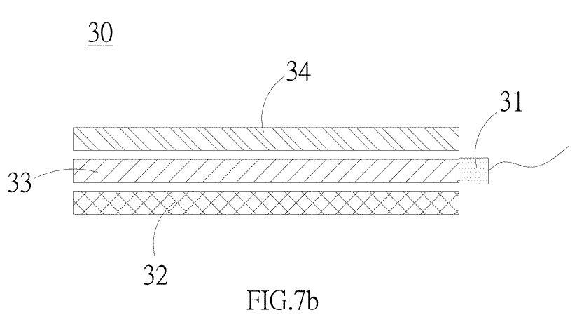

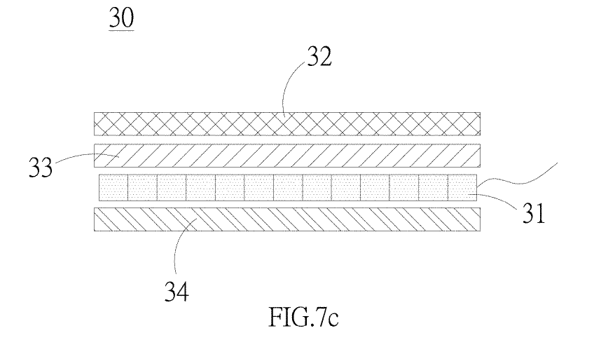

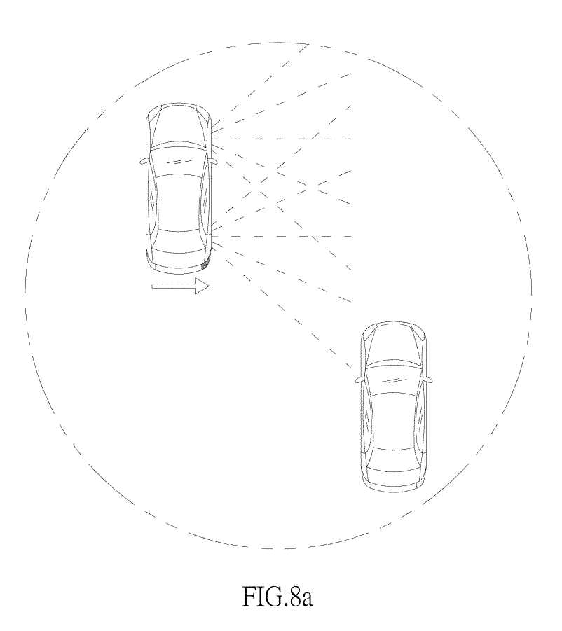

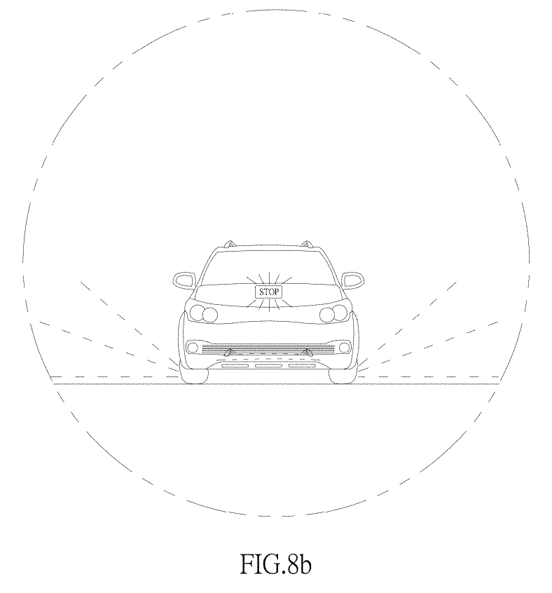

FIG. 6 is a block diagram of the power supply device used for a wheel rim and the light-emitting device in accordance with the first embodiment of the present invention connected with the driving vehicle. FIG. 7a is a schematic view of a first embodiment of the light-emitting device of the present invention. FIG. 7b is a schematic view of a second embodiment of the light-emitting device of the present invention. FIG. 7c is a schematic view of a third embodiment of the light-emitting device of the present invention. FIG. 8a is a schematic view showing that the power supply device in accordance with the first embodiment of the present invention is mounted to a wheel rim and controlled by an electronic control unit to perform a right turning. FIG. 8b is a schematic view showing that the power supply device in accordance with the first embodiment of the present invention is mounted to a wheel rim and controlled by an electronic control unit to perform a brake.

As shown in FIG. 6, the power supply device 10 used for a wheel rim of the present invention is connected with an electronic control unit 40 of a vehicle in a wireless or wired way. The electronic control unit 40 controls the power supply device 10 for transmitting power to the light-emitting device 30. For example, each wheel rim 20 at left and right sides of a vehicle is provided with the power supply device 10 and the light-emitting device 30. When the vehicle is driving, the power supply device 10 will generate power through turning the wheel rim 20. The operation is controlled by the electronic control unit 40 according to the driving information. Each power supply device 10 performs the power transmission according to the command of the electronic control unit 40. As shown in FIG. 8a, when the driver wants to turn right, the electronic control unit 40 is operated to send a command to the power supply device 10 on the right wheel rim 20. The power supply device 10 transmits power to the light-emitting device 30 on the right wheel rim 20 according to the command, such that the light-emitting device 30 can emit light. As shown in FIG. 8b, when the driver brakes the vehicle, the light-emitting device 30 will also emit light. The present invention provides a warning effect when the driver changes lanes, makes a turn or brakes the vehicle. Furthermore, as shown in FIG. 6 and FIG. 7a, the light-emitting device 30 comprises a light-emitting member 31, a diffuser 32, a light guide plate 33, and a reflector 34. The diffuser 32 is disposed on the light guide plate 33. The light guide plate 33 is disposed on the reflector 34. The light-emitting member 31 is disposed at one side of the light guide plate 33. As shown in FIG. 7b and FIG. 7c, the diffuser 32 may be disposed under the light guide plate 33. The light guide plate 33 is disposed under the reflector 34. The light-emitting member 31 is disposed at one side of the light guide plate 33. Besides, the light-emitting member 31 may be disposed under the light guide plate 33. The diffuser 32 is disposed on the light guide plate 33. The reflector 34 is disposed under the light-emitting member 31. Through the change of structural assembly, the light range of the light-emitting member 31 can be broad. Preferably, the light-emitting member 31 is a light emitting diode, but not limited.

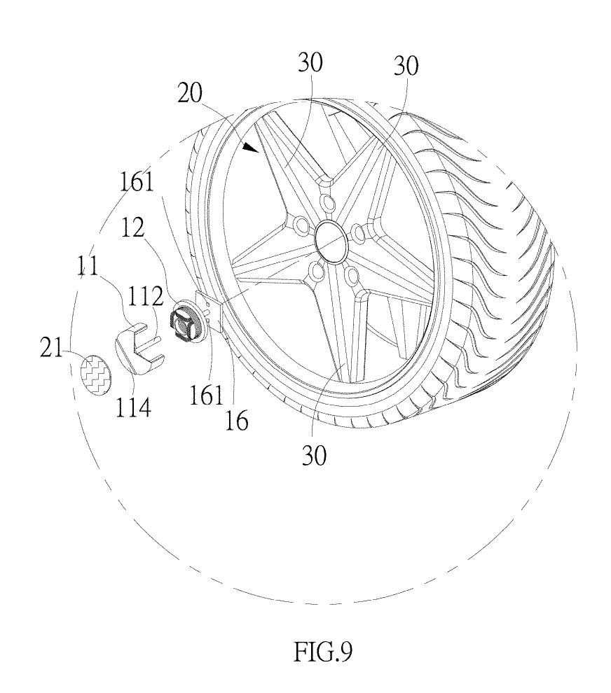

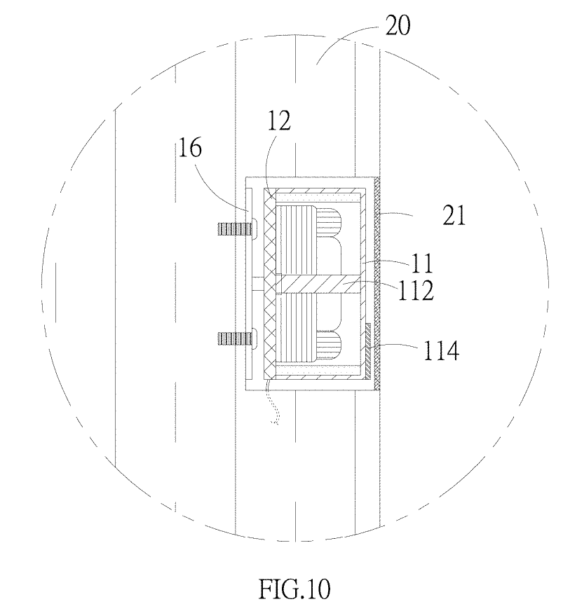

FIG. 9 and FIG. 10 are first and second schematic views of the power supply device used for a wheel rim in accordance with a second embodiment of the present invention. In the second embodiment, the power supply device of the present invention further comprises a retaining board 16. The retaining board 16 has an installation hole 161. The retaining board 16 is fixed to the wheel rim 20 through a screw locked to the installation hole 161. The seat 12 is connected to the retaining board 16. The seat 12 is disposed on the wheel rim 20 through the retaining board 16.

The power supply device used for a wheel rim of the present invention has the following features.

1. The power supply device is disposed on the wheel rim. It is convenient and easy for the wiring of the light-emitting device located close to the wheel rim.

2. The power supply device itself can generate power by means of turning of the wheel rim, without a vehicular battery to supply power, such that the light-emitting device can get the required power.

3. The power supply device is further connected to the electronic control unit. According to the control command of the electronic control unit, the light-emitting devices can emit light simultaneously or individually.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A power supply device used for a wheel rim, mounted on a wheel rim of a vehicle, the power supply device comprising:
a magnetism assembly, comprising a base; an axle member disposed at a center of a first side of the base; a magnet disposed around the first side of the base; and a weight block disposed on a second side of the base opposite the axle member;
a seat, disposed on the wheel rim, a first side of the seat being provided with an axle seat for connection of the axle member, the seat being driven by the wheel rim to turn relative to the magnetism assembly;
a coil module, disposed on the first side of the seat, the coil module being disposed around the axle seat; and
a control module, disposed inside the seat, wherein when the seat is turned to generate power through the magnet and the coil module, the control module selectively transmits the power to a light-emitting device provided on the wheel rim.

2. The power supply device used for a wheel rim as claimed in claim 1, further comprising a power storage module disposed inside the seat and connected with the control module for storing the power generated by the magnet and the coil module.

3. The power supply device used for a wheel rim as claimed in claim 1, wherein the power supply device is embedded at a center of the wheel rim.

4. The power supply device used for a wheel rim as claimed in claim 1, wherein the power supply device is embedded in a recess of a center of the wheel rim, and the wheel rim is provided with a wheel rim cover to cover the power supply device.

5. The power supply device used for a wheel rim as claimed in claim 1, wherein the seat is disposed on the wheel rim by binding.

6. The power supply device used for a wheel rim as claimed in claim 2, wherein the seat is disposed on the wheel rim by binding.

7. The power supply device used for a wheel rim as claimed in claim 3, wherein the seat is disposed on the wheel rim by binding.

8. The power supply device used for a wheel rim as claimed in claim 4, wherein the seat is disposed on the wheel rim by binding.

9. The power supply device used for a wheel rim as claimed in claim 1, further comprising a retaining board having an installation hole, the retaining board being fixed to the wheel rim through a screw locked to the installation hole, the seat being connected to the retaining board and disposed on the wheel rim through the retaining board.

10. The power supply device used for a wheel rim as claimed in claim 2, further comprising a retaining board having an installation hole, the retaining board being fixed to the wheel rim through a screw locked to the installation hole, the seat being connected to the retaining board and disposed on the wheel rim through the retaining board.

11. The power supply device used for a wheel rim as claimed in claim 3, further comprising a retaining board having an installation hole, the retaining board being fixed to the wheel rim through a screw locked to the installation hole, the seat being connected to the retaining board and disposed on the wheel rim through the retaining board.

12. The power supply device used for a wheel rim as claimed in claim 4, further comprising a retaining board having an installation hole, the retaining board being fixed to the wheel rim through a screw locked to the installation hole, the seat being connected to the retaining board and disposed on the wheel rim through the retaining board.

13. The power supply device used for a wheel rim as claimed in claim 1, connected with an electronic control unit 40 of the vehicle in a wireless or wired way, the electronic control unit controlling the power supply device for transmitting the power to the light-emitting device.

14. The power supply device used for a wheel rim as claimed in claim 1, wherein the light-emitting device comprises a light-emitting member, a diffuser, a light guide plate, and a reflector.

15. The power supply device used for a wheel rim as claimed in claim 14, wherein the diffuser is disposed on the light guide plate, the light guide plate is disposed on the reflector, and the light-emitting member is disposed at one side of the light guide plate.

16. The power supply device used for a wheel rim as claimed in claim 14, wherein the diffuser is disposed under the light guide plate, the light guide plate is disposed under the reflector, and the light-emitting member is disposed at one side of the light guide plate.

17. The power supply device used for a wheel rim as claimed in claim 1, wherein the light-emitting device comprises a light-emitting member and a light guide plate.

18. The power supply device used for a wheel rim as claimed in claim 17, wherein the light-emitting member is disposed under the light guide plate.

19. The power supply device used for a wheel rim as claimed in claim 18, wherein the light-emitting device further comprises a diffuser disposed on the light guide plate and a reflector disposed under the light-emitting member.

20. The power supply device used for a wheel rim as claimed in claim 14, wherein the light-emitting member is a light emitting diode.

21. The power supply device used for a wheel rim as claimed in claim 1, wherein the light-emitting device is disposed on a surface of the wheel rim.
